(19) United States
(12) Patent Application Publication
(10) Pub. No.: US 2026/0253486 A1
(43) Pub. Date: Aug. 27, 2026

(54) UNSEALING DETECTION MEMBER AND UNSEALING DETECTION SYSTEM

(71) Applicant: Maxell, Ltd., Kyoto (JP)

(72) Inventors: Tomoki YAMAMOTO, Kyoto (JP); Takuya SHIMIZU, Kyoto (JP); Yoko TSUJI, Kyoto (JP); Kazuo SHIKITA, Kyoto (JP); Hirotoshi KEMI, Kyoto (JP)

(21) Appl. No.: 19/160,092

(22) PCT Filed: Nov. 1, 2023
(86) PCT No.: PCT/JP2023/039507

§ 371 Date: Aug. 27, 2025

(30) Foreign Application Priority Data
Mar. 3, 2023 (JP) 2023-032481

(51) Int. Cl. G08B 29/14; G08B 25/00

(52) U.S. Cl. CPC G08B 29/14; G08B 25/009

(57) ABSTRACT

Provided are an unsealing detection member and an unsealing detection system capable of detecting that a tape is peeled off. Further, the present invention contributes to the sustainable development goals (SDGs) “Goal 9: Build resilient infrastructure, promote inclusive and sustainable industrialization and foster innovation”. Therefore, the present invention includes a tape base material attached to an object to be sealed, a tape release material disposed to cover the tape base material and configured to be peeled off from the tape base material in a process of peeling an unsealing detection member from the object to be sealed, a battery mounted on the tape base material, a wiring disposed in a region where the tape base material and the tape release material face each other and configured such that the presence/absence of transmission of a power supply or a signal changes according to whether or not the tape release material is peeled off from the tape base material, and an alarm mounted on the tape base material and configured to operate with power from the battery and output first notification information reflecting information on the presence/absence of transmission in the wiring to the outside.

### TECHNICAL FIELD

The present invention relates to an unsealing detection member and an unsealing detection system that detect unsealing of an object to be sealed.

### BACKGROUND ART

Patent Document 1 discloses a non-contact communication medium that, when a disconnection occurs in a disconnection detecting wiring, transmits the fact in a non-contact manner. The non-contact communication medium includes a film substrate having two regions with a perforation line interposed therebetween, an antenna formed in one region, an IC chip arranged in the one region, and a disconnection detecting wiring formed across the perforation line. The IC chip detects disconnection of the disconnection detecting wiring and transmits the detection result in a non-contact manner via the antenna.

Patent Document 2 discloses a crack detection label set that accurately and promptly detects occurrence of a crack in an adherend. The crack detection label set includes a detection label and an RF label. The detection label includes a wiring layer in which both ends are open and a plurality of slits are formed therein. The RF label includes an antenna formed on a base material and an IC chip disposed on the base material, and the IC chip is connected to both ends of a wiring layer in the detection label via two auxiliary wirings formed on the base material.

### RELATED ART DOCUMENTS

### Patent Documents

Patent Document 1: Japanese Patent Application Laid-open Publication No. 2020-52604

Patent Document 2: Japanese Patent Application Laid-open Publication No. 2021-39721

### SUMMARY OF THE INVENTION

### Problems to be Solved by the Invention

For example, a technique of sealing an object to be sealed by attaching a tape is widely used in various fields. When such a technique is used, it is desirable to detect at an early stage that the tape has been peeled off or cut. Under such circumstances, for example, a tape that visually leaves a trace of peeling is known. However, in this case, since visual confirmation is required, it may take time to recognize that the tape has been peeled off, and there is a possibility that real-time properties cannot be sufficiently obtained.

On the other hand, in order to obtain the real-time properties, for example, it is conceivable to use techniques as disclosed in Patent Documents 1 and 2. The technique of Patent Document 1 can detect that the film substrate has been cut along the perforation line, and the technique of Patent Document 2 can detect that the wiring layer in the detection label has been cut along the slit. However, in the techniques disclosed in Patent Documents 1 and 2, for example, it is possible to detect that the tape has been cut, but it may be difficult to detect that the tape has been peeled off.

The present invention has been made in view of such circumstances, and an object of the present invention is to provide an unsealing detection member and an unsealing detection system capable of detecting that a tape is peeled off.

The foregoing and other objects and novel features of the present invention will become apparent from the description of the present specification and the accompanying drawings.

### Means for Solving the Problems

In order to solve the above problems, an embodiment of the present invention may be configured, for example, as described in the claims. The present application includes a plurality of means for solving the above-described problems, and an example thereof includes: a tape base material attached to an object to be sealed, a tape release material disposed to cover the tape base material and configured to be peeled off from the tape base material in a process of peeling an unsealing detection member from the object to be sealed, a battery mounted on the tape base material, a wiring disposed in a region where the tape base material and the tape release material face each other and configured such that the presence/absence of transmission of a power supply or a signal changes according to whether or not the tape release material is peeled off from the tape base material, and an alarm mounted on the tape base material and configured to operate with power from the battery and output first notification information reflecting information on the presence/absence of transmission in the wiring to the outside.

### Effects of the Invention

If effects obtained by representative embodiments of the inventions disclosed in the present application are briefly described, it is possible to detect that the tape is peeled off.

### BRIEF DESCRIPTIONS OF THE DRAWINGS

FIG. 1 is a top view illustrating a schematic configuration example of an unsealing detection member according to a first embodiment.

FIG. 2 is a perspective view illustrating a schematic configuration example of the unsealing detection member according to the first embodiment.

FIG. 3 is a cross-sectional view illustrating a more detailed configuration example of the unsealing detection member illustrated in FIGS. 1 and 2.

FIG. 4A is a cross-sectional view illustrating an example of a state after peeling occurs in an unsealing detection tape illustrated in FIG. 3.

FIG. 4B is a cross-sectional view illustrating an example of a state after cutting occurs in an unsealing detection tape illustrated in FIG. 3.

FIG. 5 is a diagram illustrating a specific example of an alarm in FIG. 1 and the like.

FIG. 6A is a diagram illustrating an example of sealing an object to be sealed using the unsealing detection member illustrated in FIGS. 1 and 2.

FIG. 6B is a diagram illustrating an example of sealing an object to be sealed using the unsealing detection member illustrated in FIGS. 1 and 2.

FIG. 7 is a schematic diagram illustrating an example of an operation mode at the time of installing an unsealing detection member in an unsealing detection system according to a second embodiment.

FIG. 8A is a schematic diagram illustrating an example of an operation mode at the time of unsealing detection by an unsealing detection member in the unsealing detection system according to the second embodiment.

FIG. 8B is a schematic diagram illustrating an example of an operation mode different from that of FIG. 8A.

FIG. 8C is a schematic diagram illustrating an example of an operation mode further different from that of FIG. 8A.

FIG. 8D is a schematic diagram illustrating an example of an operation mode still further different from that of FIG. 8A.

FIG. 9 is a schematic diagram illustrating an example of a disconnection detection method by an alarm illustrated in FIG. 1 and the like in an unsealing detection member according to a third embodiment. FIG. 10A is a circuit block diagram illustrating a detailed configuration example of the alarm illustrated in FIG. 1 and the like and an example of a disconnection detection method different from that in FIG. 9 in the unsealing detection member according to the third embodiment.

FIG. 10B is a timing chart illustrating an operation example of the alarm in FIG. 10A.

FIG. 11A is a circuit block illustrating a detailed configuration example of an alarm different from that in FIG. 10A.

FIG. 11B is a timing chart illustrating an operation example of the alarm in FIG. 11A.

FIG. 12A is a circuit block illustrating a detailed configuration example of an alarm different from that in FIG. 11A.

FIG. 12B is a timing chart illustrating an operation example of the alarm in FIG. 12A.

FIG. 13 is a cross-sectional view illustrating a detailed configuration example of an unsealing detection member according to a fourth embodiment.

FIG. 14A is a circuit block diagram illustrating a detailed configuration example of an alarm illustrated in FIG. 13.

FIG. 14B is a timing chart illustrating an operation example of the alarm in FIG. 14A.

FIG. 15A is a circuit block diagram illustrating a detailed configuration example of an alarm different from that in FIG. 14A.

FIG. 15B is a timing chart illustrating an operation example of the alarm in FIG. 15A.

FIG. 16A is a circuit block diagram illustrating a detailed configuration example of an alarm different from that in FIG. 15A.

FIG. 16B is a timing chart illustrating an operation example of the alarm in FIG. 16A.

FIG. 17A is a circuit block diagram illustrating a detailed configuration example of an alarm different from that in FIG. 16A.

FIG. 17B is a timing chart illustrating an operation example of the alarm in FIG. 17A.

FIG. 18 is a top view illustrating a schematic configuration example of an unsealing detection member according to a fifth embodiment.

FIG. 19 is a perspective view illustrating a schematic configuration example of the unsealing detection member according to the fifth embodiment.

### DETAILED DESCRIPTION OF PREFERRED EMBODIMENTS

Hereinafter, embodiments of the present invention will be described in detail with reference to the drawings. In all the drawings for describing the embodiments, the same members or portions having the same role are denoted by the same reference numerals in principle, and repeated description thereof will be omitted.

### First Embodiment

### <Outline of Unsealing Detection Member>

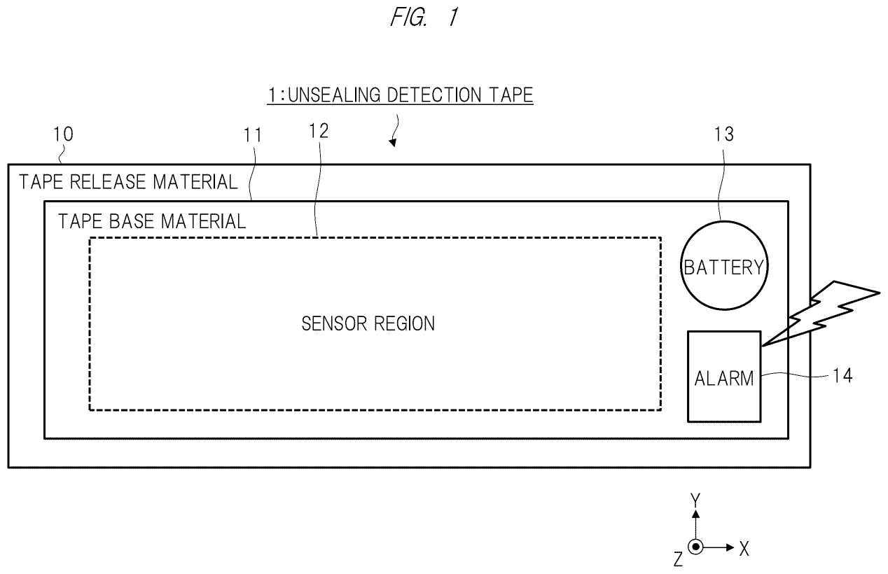

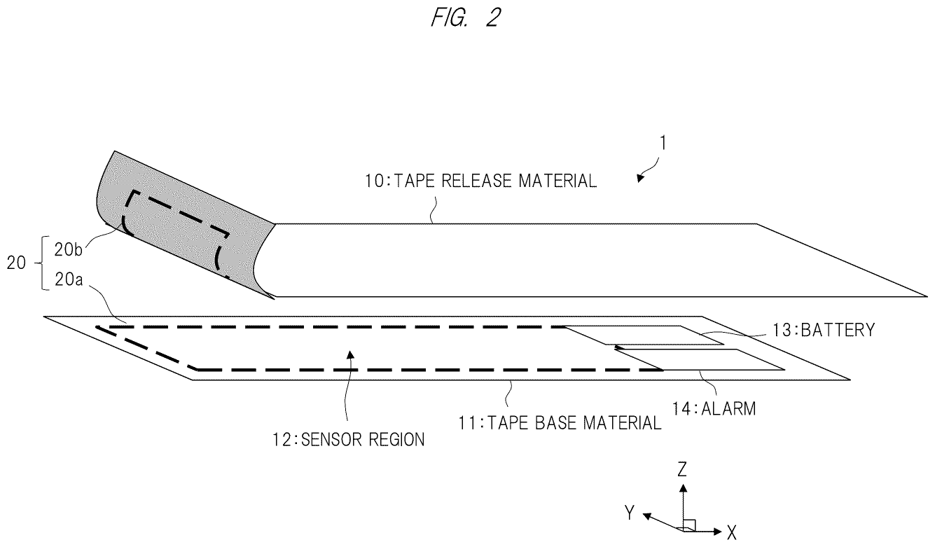

FIG. 1 is a top view illustrating a schematic configuration example of an unsealing detection member according to a first embodiment. FIG. 2 is a perspective view illustrating a schematic configuration example of the unsealing detection member according to the first embodiment. FIGS. 1 and 2 illustrate an unsealing detection tape 1 which is an example of an unsealing detection member. The unsealing detection tape 1 is used by being attached to an object to be sealed, and has a function of detecting unsealing of the object to be sealed as one of IoT technologies. In the specification, a surface direction of the unsealing detection tape 1 is an X-axis direction and a Y-axis direction orthogonal to each other, and a thickness direction of the unsealing detection tape 1 is a Z-axis direction orthogonal to the X-axis direction and the Y-axis direction. Here, the length direction of the unsealing detection tape 1 is the X-axis direction, and the width direction is the Y-axis direction.

The unsealing detection tape (unsealing detection member) 1 illustrated in FIGS. 1 and 2 includes a tape release material 10, a tape base material 11, a battery 13, and an alarm 14. The tape base material 11 is attached to the object to be sealed. The tape release material 10 is disposed so as to cover the tape base material 11. The tape release material 10 is configured to be peeled off from the tape base material 11 in the process of peeling the unsealing detection tape 1 from the object to be sealed.

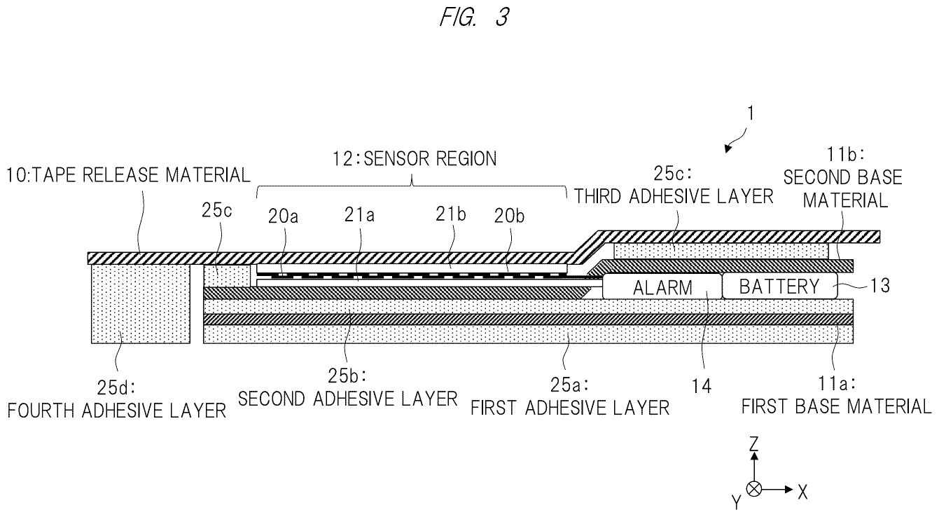

That is, here, the tape release material 10 has a larger area than the tape base material 11, and is disposed so as to completely cover the tape base material 11. Therefore, when the unsealing detection tape 1 is peeled off from the object to be sealed, an operation of peeling the tape release material 10 is inevitably performed before the tape base material 11. When the operation of peeling the tape release material 10 is performed, the tape release material 10 is peeled off from the tape base material 11. Details of this structure will be described below with reference to FIG. 3.

The battery 13 and the alarm 14 are mounted on the tape base material 11. A first wiring 20a forming a part of a loop wiring 20 is attached to the tape base material 11. On the other hand, a second wiring 20b forming another part of the loop wiring 20 is attached to the tape release material 10. Each of the first wiring 20a and the second wiring 20b is an intermittent annular wiring. However, the first wiring 20a and the second wiring 20b are attached to the tape base material 11 and the tape release material 10, respectively, so as to be in contact with each other, that is, so as to form one loop wiring 20 by contact when the tape base material 11 is covered with the tape release material 10.

A sensor region 12 is a region where the tape base material 11 and the tape release material 10 face each other, and where a wiring is formed. In the example illustrated in FIG. 2, the loop wiring 20 is formed in the sensor region 12. The wiring, here, the loop wiring 20 is configured such that the presence/absence of disconnection and the presence/absence of transmission of a power supply or a signal change according to whether or not the tape release material 10 is peeled off from the tape base material 11. Furthermore, the loop wiring 20 is configured such that the presence/absence of transmission of the power supply or the signal changes according to whether or not the unsealing detection tape 1 is cut.

Specifically, when the tape release material 10 is peeled off from the tape base material 11 with reference to a state in which the tape base material 11 is covered with the tape release material 10, a contact state between the first wiring 20a and the second wiring 20b is interrupted at least at a part, and as a result, disconnection occurs in the loop wiring 20. Further, even when the tape release material 10 and the tape base material 11 are cut on the YZ plane with a blade or the like, as a result, disconnection occurs in the loop wiring 20. In the loop wiring 20, the power supply or the signal is not transmitted due to the disconnection.

The alarm 14 operates with power from the battery 13, and outputs notification information reflecting information on the presence/absence of transmission in the wiring in the sensor region 12, in this example, information on the presence/absence of disconnection of the loop wiring 20 to the outside. The administrator of the unsealing detection tape 1 can recognize whether or not disconnection has occurred in the loop wiring 20, and furthermore, whether or not the object to be sealed has been unsealed by peeling or cutting of the unsealing detection tape 1 based on the notification information. As described above, by using the unsealing detection tape 1 according to the first embodiment, it is possible to detect peeling in addition to cutting of the unsealing detection tape 1, unlike the cases of Patent Documents 1 and 2.

Here, the battery 13 and the alarm 14 are collectively disposed on one end side in the X-axis direction, but may be separately disposed on both ends in the X-axis direction in some cases. However, from the viewpoint of reuse of the unsealing detection tape 1, it is desirable to arrange the unsealing detection tapes together on one end side. Specifically, the sensor region 12 can be disposable, but a portion of the battery 13 and the alarm 14 can be reused as long as the battery and the alarm remain in a state of being attached to the object to be sealed. Therefore, by collectively disposing these portions on one end side, these portions become easier to remain, and work associated with reuse is also facilitated.

In addition, as disclosed in Patent Documents 1 and 2, when a contactless IC tag is used for the alarm 14, the battery 13 is unnecessary. However, in a case where the contactless IC tag is used, it is necessary to install a reader/writer in a relatively small area centered on the contactless IC tag, and a desired function cannot be realized unless the contactless IC tag is used as a set with the reader/writer at least. For this reason, a certain degree of restriction is applied to the place where the unsealing detection tape 1 is attached, and for example, it may be difficult to attach the unsealing detection tape 1 to a moving object to be sealed or the like.

Therefore, in the unsealing detection tape 1 illustrated in FIGS. 1 and 2, the battery 13 is mounted, and the alarm 14 is operated by the battery. As a result, for example, in a case where the alarm 14 is configured by a buzzer, a desired function can be realized even with the unsealing detection tape 1 alone. Further, the restriction on the place where the unsealing detection tape 1 is attached is alleviated, and for example, the unsealing detection tape 1 can be attached to a moving object to be sealed or the like.

### <Details of Unsealing Detection Member>

FIG. 3 is a cross-sectional view illustrating a more detailed configuration example of the unsealing detection member illustrated in FIGS. 1 and 2. Here, an example of a cross-sectional structure of the unsealing detection tape 1 on the XZ plane is illustrated. The unsealing detection tape 1 illustrated in FIG. 3 includes a first base material 11a, a second base material 11b, and the tape release material 10 which are stacked and mounted in order from the side of the object to be sealed in the Z-axis direction. The first base material 11a and the second base material 11b constitute the tape base material 11 illustrated in FIGS. 1 and 2. Each member constituting the unsealing detection tape 1 is appropriately adhered using a first adhesive layer 25a, a second adhesive layer 25b, a third adhesive layer 25c, and a fourth adhesive layer 25d.

A film substrate 21b on which the second wiring 20b is formed is attached to the tape release material 10. The film substrate 21b may be, for example, flexible printed circuits (FPCs) or the like. The first base material 11a is for mounting the battery 13 and the alarm 14. The second base material 11b is for attaching a film substrate 21a on which the first wiring 20a is formed. The film substrate 21a may also be, for example, FPCs or the like. Both the first wiring 20a and the second wiring 20b are formed in a dotted line shape, and are arranged such that gaps in one wiring are filled by the other wiring, thereby forming the loop wiring 20 as a whole.

The second base material 11b is provided so that the sensor region 12 in which the first wiring 20a and the second wiring 20b are formed can be sandwiched between the tape release material 10 and the second base material 11b in the Z-axis direction. Furthermore, the second base material 11b is provided so that a state in which the sensor region 12 is sandwiched can be maintained by the third adhesive layers 25c formed at two positions in the X-axis direction.

The first adhesive layer 25a is a layer for adhering the first base material 11a and the object to be sealed. The first adhesive layer 25a is formed on the lower surface of the first base material 11a, that is, the entire surface facing the object to be sealed. The second adhesive layer 25b is a layer for adhering the first base material 11a and the second base material 11b and adhering the first base material 11a and the battery 13/alarm 14. The third adhesive layer 25c is a layer for adhering the tape release material 10 and the second base material 11b. The third adhesive layer 25c is formed in a region between the tape release material 10 and the second base material 11b excluding the sensor region 12. The fourth adhesive layer 25d is a layer for adhering the tape release material 10 and the object to be sealed. The outer edge of the unsealing detection tape 1 adheres to the object to be sealed via the fourth adhesive layer 25d.

Here, in the process of peeling the unsealing detection tape 1 from the object to be sealed, in order for the tape release material 10 is first peeled off from the tape base material 11, here, the second base material 11b, at least the adhesive strength of the third adhesive layer 25c is lower than that of the first adhesive layer 25a. In addition, it is desirable that the adhesive strength of the second adhesive layer 25b is sufficiently high in order to prevent a portion of the battery 13/alarm 14 from being peeled off from the tape base material 11, here, the first base material 11a and broken in the process of peeling the unsealing detection tape 1 from the object to be sealed, and in order to enable the notification operation to be performed normally.

In a case where the adhesive strength of the fourth adhesive layer 25d is higher than that of the first adhesive layer 25a, when the tape release material 10 is peeled off from the object to be sealed, there is a possibility that the entire unsealing detection tape 1 is peeled off from the object to be sealed. Even when the tape release material 10 is peeled off, it is desirable that a portion of the battery 13/alarm 14 remain in a state of being stuck to the object to be sealed as much as possible.

In view of the above, the adhesive strength of each adhesive layer is preferably, for example, “second adhesive layer 25b>first adhesive layer 25a>fourth adhesive layer 25d>third adhesive layer 25c”. By making the adhesive strength of the second adhesive layer 25b higher than that of the first adhesive layer 25a, even in a case where the first adhesive layer 25a is peeled off from the object to be sealed after the tape release material 10 is peeled off, the notification operation by the portion of the battery 13/alarm 14 can be continued.

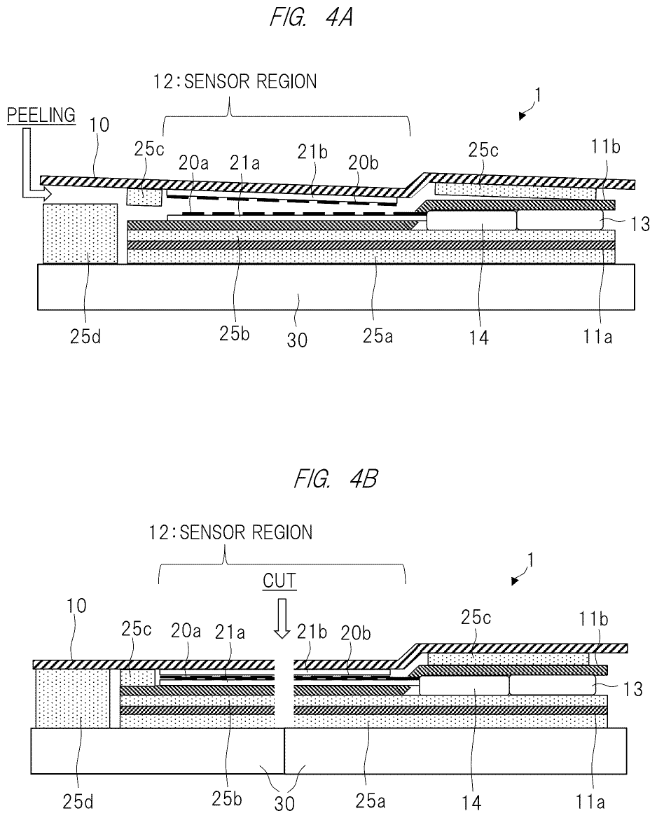

FIG. 4A is a cross-sectional view illustrating an example of a state after peeling occurs in the unsealing detection tape illustrated in FIG. 3. FIG. 4B is a cross-sectional view illustrating an example of a state after cutting occurs in the unsealing detection tape illustrated in FIG. 3. When peeling off from an object 30 to be sealed occurs, the adhesive strength of the fourth adhesive layer 25d and the third adhesive layer 25c is lower than that of the second adhesive layer 25b and the first adhesive layer 25a, and therefore, typically, a state as illustrated in FIG. 4A can be obtained. As a result, disconnection occurs in the loop wiring 20 including the first wiring 20a and the second wiring 20b. In addition, for example, when cutting of the unsealing detection tape 1 occurs in accordance with the separation surface of the object 30 to be sealed, typically, a state as illustrated in FIG. 4B can be obtained. Also in this case, disconnection occurs in the loop wiring 20.

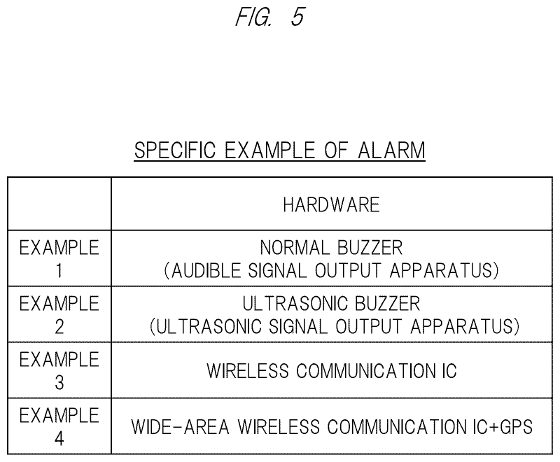

FIG. 5 is a diagram illustrating a specific example of the alarm in FIG. 1 and the like. As illustrated in FIG. 5, the alarm 14 may include a normal buzzer, in other words, an audible signal output apparatus. The normal buzzer emits an audible warning sound or the like when the unsealing detection tape 1 is peeled off or cut. Furthermore, the alarm 14 may include an ultrasonic buzzer, in other words, an ultrasonic signal output apparatus. The ultrasonic buzzer emits an ultrasonic warning sound or the like when the unsealing detection tape 1 is peeled off or cut. In this case, an alarm is recognized via a receiver that has received the ultrasonic wave.

Furthermore, the alarm 14 may include, for example, a wireless communication IC for Bluetooth Low Energy (BLE (registered trademark) ), a wireless LAN, in other words, for Wi-Fi (registered trademark). Furthermore, the alarm 14 may include, for example, a wide-area wireless communication IC for low power wide area (LPWA), long term evolution (LTE), or 5th generation (5G). The wide-area wireless communication IC may be equipped with a global positioning system (GPS) sensor that acquires position information. By using the wireless communication IC or the wide-area wireless communication IC, notification information including various contents can be transmitted.

### Sealing Example by Unsealing Detection Member

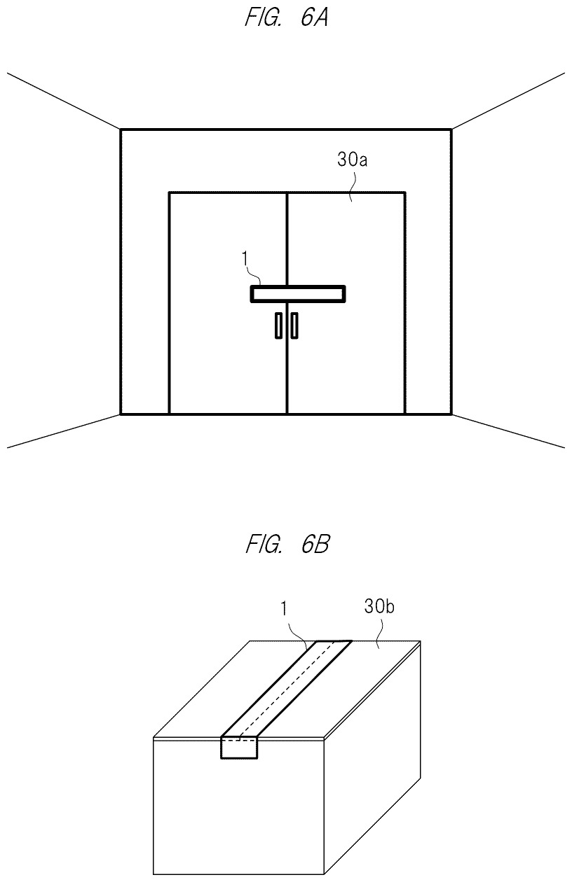

FIGS. 6A and 6B are diagrams illustrating exemplary sealing of an object to be sealed using the unsealing detection member illustrated in FIGS. 1 and 2. In FIG. 6A, an object 30a to be sealed is a double door. The unsealing detection tape 1 is attached across the unseal line of the door so that the door cannot be opened. At this time, for example, facility wiring work or the like is unnecessary, so that convenience can be improved, operation cost can be reduced, and the like. That is, for example, it is not necessary to attach an opening/closing sensor or the like to the door and to route the wiring from the opening/closing sensor.

As a specific application, for example, there is an application in which unsealing detection is performed using an emergency facility such as an emergency door release handle or a door of various emergency facilities, as an object to be sealed. In addition, there is an application in which unsealing detection is performed using a periodic inspection facility such as a facility in which an inspector enters once in several months, as an object to be sealed. At this time, if a tape that visually leaves a trace of peeling as described above is used, the timing at which unsealing can be detected is the inspection timing. When the method of the first embodiment is used, the timing at which the unsealing can be detected is real time.

In addition, in a facility such as a factory, there is an application in which unsealing monitoring is performed using an unsealing prohibited facility as an object to be sealed. Furthermore, in a hospital, a nursing care facility, a school, or the like, there is an application in which unsealing detection/unsealing monitoring is performed using equipment that is prohibited from moving, that is, an object that is not desired to be moved without permission, as an object to be sealed. In any application, as described above, facility wiring work or the like is unnecessary, and the unsealing detection tape 1 may be simply attached to the object to be sealed, so that convenience can be improved, operation cost can be reduced, and the like.

In FIG. 6B, an object 30b to be sealed is a moving delivery object, for example, cardboard. The unsealing detection tape 1 is used, for example, in place of a packing tape or the like for sealing cardboard. The unsealing detection tape 1 is mounted with the battery 13, and does not require a reader/writer that performs power supply unlike the case of using the contactless IC tag as disclosed in Patent Documents 1 and 2. Therefore, the unsealing detection tape 1 can be attached to a moving object to be sealed.

### Main Effects of First Embodiment

As described above, the unsealing detection member according to the first embodiment includes wiring configured such that the presence/absence of transmission of a power supply or a signal changes according to whether or not the tape release material 10 is peeled off from the tape base material 11, and the unsealing detection is performed using the wiring. This makes it possible to detect that the tape has been peeled off in addition to that the tape has been cut. In addition, since the unsealing detection can be performed only by attaching the unsealing detection member to the object to be sealed, improvement in convenience, reduction in operation cost, and the like can be realized.

### Second Embodiment

### <Operation Mode of Unsealing Detection Member (Unsealing Detection System)>

### [At Time of Initial Installation]

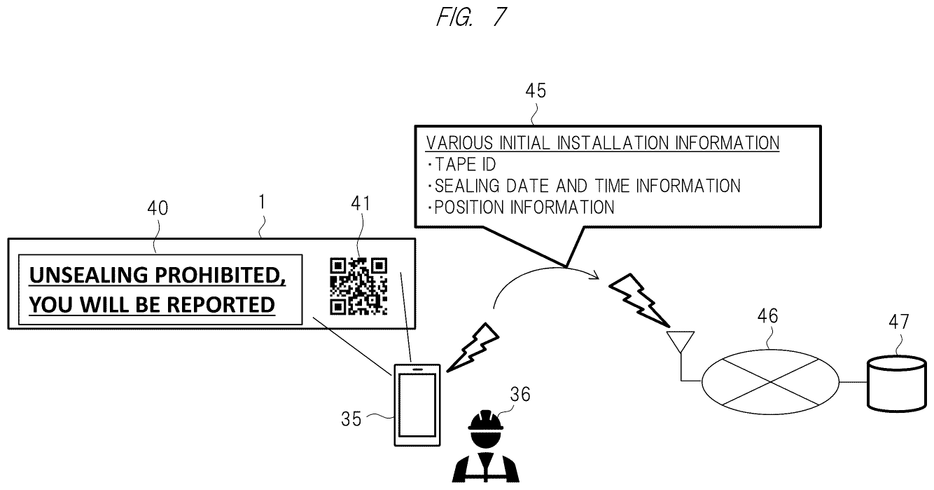

FIG. 7 is a schematic diagram illustrating an example of an operation mode at the time of installing an unsealing detection member in an unsealing detection system according to a second embodiment. FIG. 7 illustrates an unsealing detection system including a network 46 and a management server 47 in addition to the unsealing detection tape 1 illustrated in FIG. 1 and the like. Here, the tape release material 10 illustrated in FIG. 1 and the like is made of release paper. On the release paper, tape IDs for identifying individual unsealing detection tapes 1 are printed as two-dimensional codes 41. In addition, on the release paper, an unsealing warning message 40 or the like to be recognized by surrounding people is also printed.

For example, when the unsealing detection tape 1 is attached to the object to be sealed, the user such as an operator 36 transmits various types of initial installation information 45 to the management server 47 via the network 46 using an information terminal 35, specifically, a mobile terminal such as a smartphone or a tablet PC. The initial installation information 45 includes, for example, sealing date and time information, position information, and the like in addition to the tape ID.

Specifically, the operator 36 acquires the tape ID by reading the two-dimensional code 41 using a camera of the information terminal 35. Then, the information terminal 35 transmits the acquired tape ID to the management server 47 in association with sealing date and time information and position information. At this time, the sealing date and time information may be date and time information managed by the information terminal 35. The position information may be GPS information acquired by a GPS sensor of the information terminal 35 or information manually input using the information terminal 35. The management server 47 stores, as a management database, the initial installation information 45 indicating a correspondence relationship with the tape ID, the sealing date and time information, and/or the position information transmitted from the information terminal 35 in the memory.

### [When Unsealing is Detected]

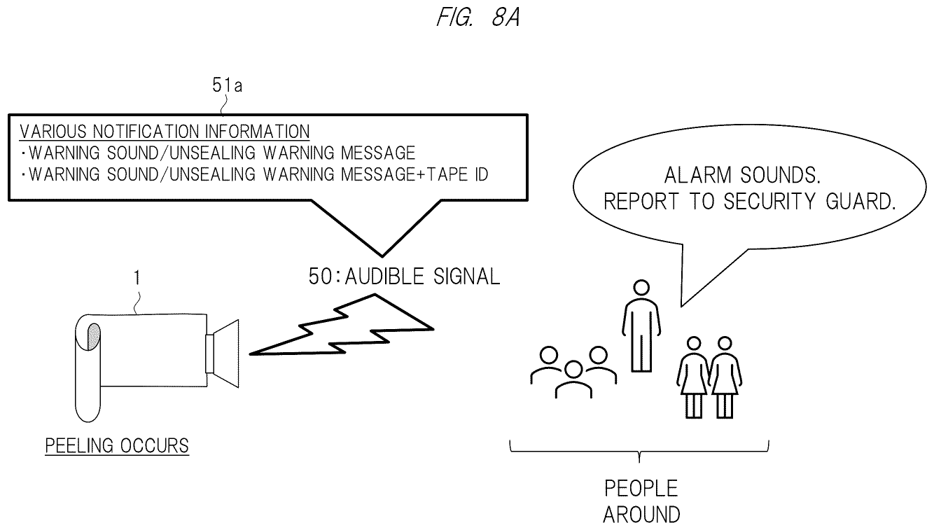

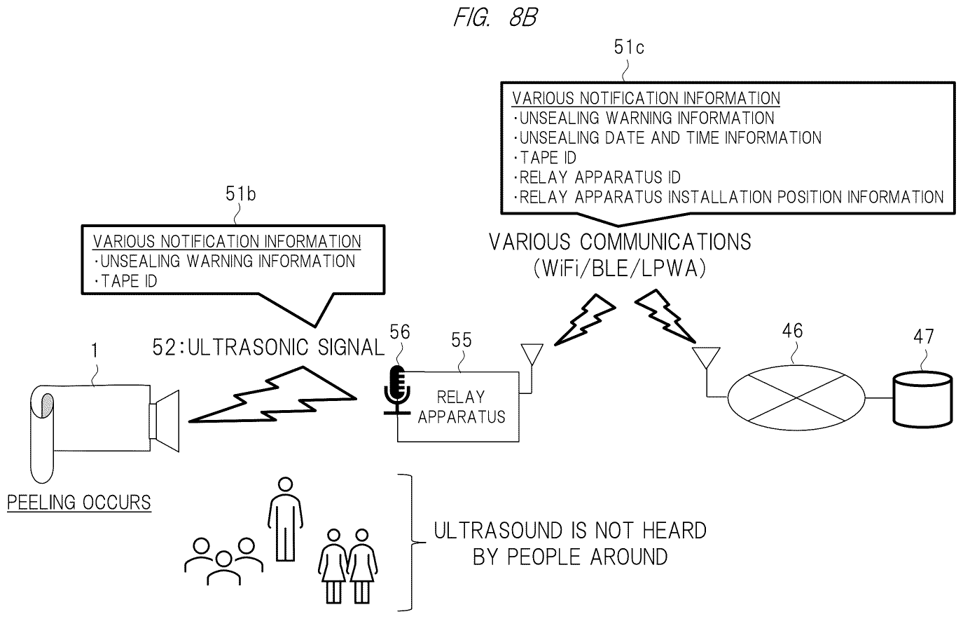

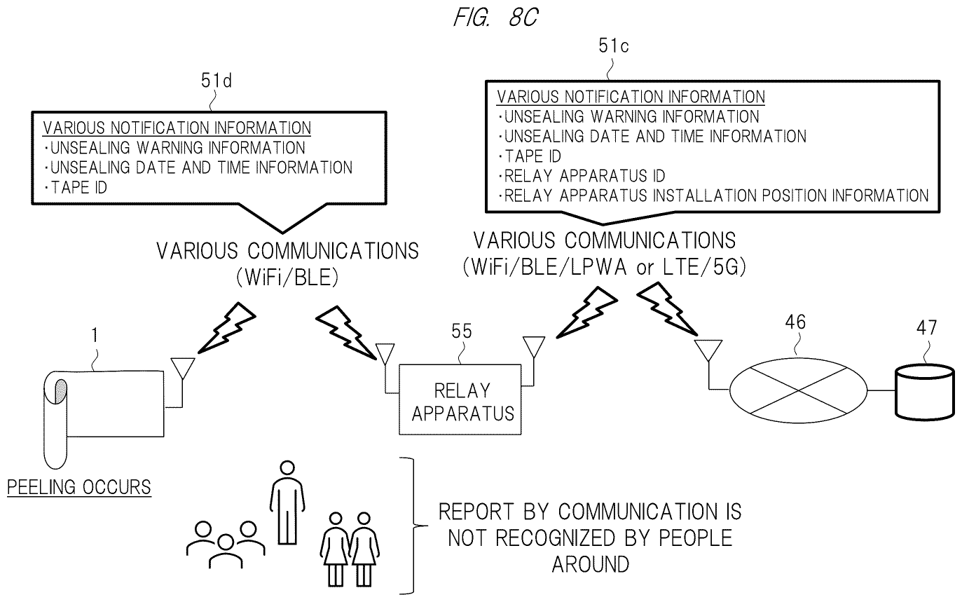

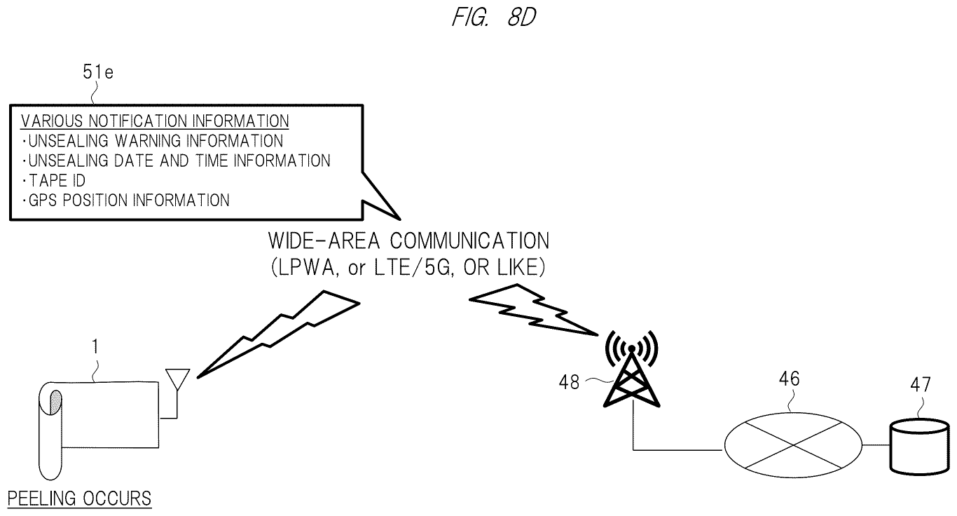

FIGS. 8A, 8B, 8C, and 8D are schematic diagrams illustrating an example of an operation mode at the time of unsealing detection by the unsealing detection member in the unsealing detection system according to the second embodiment. FIG. 8A illustrates an operation mode in a case where a normal buzzer is used as the alarm 14 in the unsealing detection tape 1. When detecting unsealing, that is, peeling or cutting of the unsealing detection tape 1, the alarm 14 in the unsealing detection tape 1 outputs various notification information 51a to the outside using an audible signal 50, in other words, an audible sound.

The various notification information 51a may include, for example, a warning sound/unsealing warning message, a tape ID, and the like. In a case where the unsealing warning message or the tape ID is output, for example, a controller may be provided in the alarm 14 in addition to the normal buzzer, and the controller may store contents to be output in advance and drive the normal buzzer, for example, an audio speaker or the like based on the stored contents.

People around the unsealing detection tape 1 recognize some kind of abnormality by hearing the warning sound and, for example, contact an administrator or the like responsible for security. As a result, the administrator or the like recognizes the unsealing of the unsealing detection tape 1. Therefore, the installation place of the unsealing detection tape 1 is desirably a place where there are many people/users, such as a public transportation facility or a shopping mall. In other words, it is desirable that the environment is sufficient if the surrounding user receives the warning sound, and the warning sound is used in a case where the administrator in the remote location does not need to directly hear the warning sound.

The unsealing detection tape 1 illustrated in FIG. 8A can serve the purpose of allowing an administrator to recognize the unsealing of the unsealing detection tape 1 by itself without requiring network connection or the like. That is, it is not necessary to provide some equipment outside including an external power supply, and wiring to the unsealing detection tape 1 is also unnecessary. Therefore, for example, benefits can be obtained from the viewpoint of convenience, operation cost, and the like.

FIG. 8B illustrates an operation mode in a case where an ultrasonic buzzer is used as the alarm 14 in the unsealing detection tape 1. Here, as the unsealing detection system, a relay apparatus 55, a network 46, and a management server 47 are provided in addition to the unsealing detection tape 1. The relay apparatus 55 relays information transmission from the unsealing detection tape 1 to the management server 47.

In such an unsealing detection system, when detecting unsealing of the unsealing detection tape 1, the alarm 14 in the unsealing detection tape 1 outputs various notification information (first notification information) 51b to the outside using the ultrasonic signal 52. The various notification information 51b can include, for example, unsealing warning information, a tape ID, and the like. Specifically, for example, the ultrasonic buzzer modulates an ultrasonic signal of a certain frequency based on various notification information 51b, and outputs a modulated ultrasonic signal 52. Further, the contents of the various notification information 51b are stored in, for example, the controller as in the case of FIG. 8A.

The relay apparatus 55 includes an ultrasonic microphone 56. The ultrasonic microphone 56 demodulates the ultrasonic signal 52 to extract the various notification information 51b from the ultrasonic signal 52. Then, the relay apparatus 55 generates another notification information (second notification information) 51c reflecting £ the extracted notification information 51b, and transmits the generated notification information 51c to the management server 47 via the network 46 using various wireless signals. The various wireless signals are, for example, signals based on various wireless standards such as Wi-Fi, BLE, or LPWA.

The notification information (second notification information) 51c may include unsealing date and time information, a relay apparatus ID, relay apparatus installation position information, and the like in addition to the unsealing warning information and the tape ID notification information (first notification information) 51b. The relay apparatus ID is for identifying each relay apparatus 55, and is registered in advance in a memory or the like of the relay apparatus 55. The relay apparatus installation position information indicates the position where the relay apparatus 55 is installed, and is, for example, information manually registered in the memory of the relay apparatus 55 when the relay apparatus 55 is installed or acquired by mounting a GPS sensor on the relay apparatus 55. The unsealing date and time information may be, for example, information obtained based on the reception time of the ultrasonic signal 52 by the relay apparatus 55 or the like.

In the communication path between the relay apparatus 55 and the management server 47, it is easy to secure a larger communication capacity than that between the unsealing detection tape 1 and the relay apparatus 55. Therefore, it is advantageous to generate notification information 51c obtained by adding further information to the notification information 51b using the relay apparatus 55. For example, assuming that the initial installation illustrated in FIG. 7 is performed, the management server 47 can recognize the position information by the tape ID. In this case, the notification information 51c does not particularly need to include relay apparatus installation position information. On the other hand, in a case where it is assumed that the tape ID and the position information are not associated in advance, the position information of the unsealing detection tape 1 can be replaced with the relay apparatus installation position information.

When the unsealing detection tape 1 is used in combination with the relay apparatus 55, for example, a method of specifying one unsealing detection tape 1 by a combination of a relay apparatus ID and a tape ID may be used. In this case, if the relay apparatus 55 is different, the tape IDs can be overlapped, and thus, for example, the number of bits required for the tape ID can be reduced. At this time, for example, the plurality of unsealing detection tapes 1 may be allocated to one relay apparatus 55 by changing the frequency of the ultrasonic signal for each of the plurality of unsealing detection tapes 1.

Unlike the case of FIG. 8A, the unsealing detection tape 1 illustrated in FIG. 8B does not generate noise to people around the unsealing detection tape 1. Therefore, the unsealing detection tape 1 can be installed in various places as long as it is a place where external power can be supplied to the relay apparatus 55, such as a factory, a building, a school, a hospital, a store, an apartment, or a house.

FIG. 8C illustrates an operation mode in a case where a wireless communication IC is used as the alarm 14 in the unsealing detection tape 1. Here, as in the case of FIG. 8B, as the unsealing detection system, a relay apparatus 55, a network 46, and a management server 47 are provided in addition to the unsealing detection tape 1. When detecting the unsealing of the unsealing detection tape 1, the alarm 14 in the unsealing detection tape 1 transmits various notification information (first notification information) 51d to the outside using various wireless signals (first wireless signals). The various wireless signals are, for example, signals based on various wireless communication standards such as Wi-Fi and BLE.

The various notification information 51d may include, for example, unsealing date and time information and the like in addition to the unsealing warning information and the tape ID illustrated in FIG. 8B. That is, in the case of using a wireless signal, it is easier to secure the communication capacity than in the case of using an ultrasonic signal. The contents of the various notification information 51d are stored in, for example, the controller as in the case of FIG. 8A. The unsealing date and time information may be date and time information managed by the controller.

Similarly to the case of FIG. 8B, the relay apparatus 55 generates another notification information (second notification information) 51c reflecting the received notification information 51d, and transmits the generated notification information 51c to the management server 47 via the network 46 using various wireless signals (second wireless signals). The various wireless signals may be signals based on a wireless communication standard such as Wi-Fi, BLE, or LPWA as in the case of FIG. 8B, or may be signals based on a wireless communication standard for mobile phones such as LTE or 5G.

The other various items including various installation places, the ability to allocate a plurality of unsealing detection tapes 1 to one relay apparatus 55, and the like are similar to those in the case of FIG. 8B. As a main effect when compared with the case of FIG. 8B, it is possible to apply a widely known apparatus with high versatility to the alarm 14 in the unsealing detection tape 1 and the wireless device used for the relay apparatus 55. For this reason, for example, it may be beneficial from the viewpoint of reliability and practicality.

FIG. 8D illustrates an operation mode in a case where the wide-area wireless communication IC is used as the alarm 14 in the unsealing detection tape 1. Here, as the unsealing detection system, in addition to the unsealing detection tape 1, a base station 48, a network 46, and a management server 47 are provided. When detecting the unsealing of the unsealing detection tape 1, the alarm 14 in the unsealing detection tape 1 outputs various notification information 51e to the outside using various wide-area wireless signals. The various wide-area wireless signals are signals based on various wide-area wireless communication standards such as LPWA, LTE, and 5G. The base station 48 receives the notification information 51e from the unsealing detection tape 1 and transfers the notification information to the management server 47 via the network 46.

The various notification information 51e can include, for example, unsealing warning information, unsealing date and time information, a tape ID, GPS position information, and the like. As described in FIG. 8B, on the assumption that the tape ID and the position information are not associated in advance, it is necessary to notify the management server 47 of the position information of the unsealing detection tape 1 by some method. Here, the relay apparatus 55 as in the case of FIG. 8B is not provided, and it is difficult to sufficiently narrow down the position information of the unsealing detection tape 1 with the position information of the base station 48. Therefore, in this example, the alarm 14 includes a GPS sensor and transmits GPS position information as one piece of the notification information 51e.

The unsealing detection tape 1 illustrated in FIG. 8D can be installed, for example, even in a place where there are few people and there is no power supply environment around. Further, the unsealing detection tape 1 may be installed on the moving object 30b to be sealed as illustrated in FIG. 6B.

### Main Effects of Second Embodiment

As described above, by using the unsealing detection member or the unsealing detection system according to the second embodiment, effects similar to the various effects described in the first embodiment can be obtained. Furthermore, by combining the unsealing detection member with the relay apparatus, it is possible to notify the management server of more notification information, and it is also possible to manage a plurality of unsealing detection members in an integrated manner using the management server. In addition, it is also possible to cause an administrator in a remote place to recognize the unsealing detection via the management server. In particular, from the viewpoint of management of such an unsealing detection member, an unsealing detection system having high operability can be realized.

### Third Embodiment

### <Details of Alarm>

[Disconnection Detection Method of Loop Wiring (Method with Periodic Communication)]

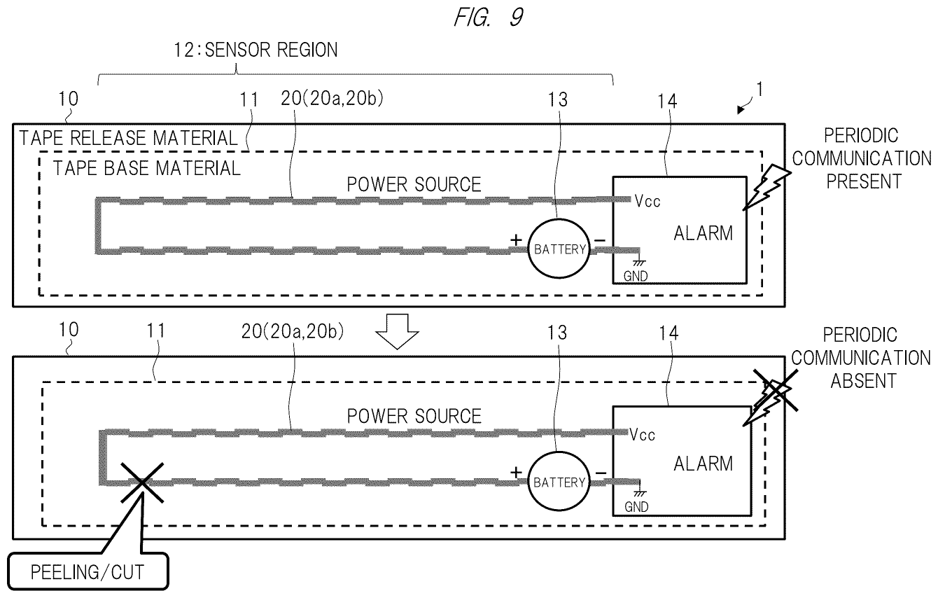

FIG. 9 is a schematic diagram illustrating an example of a disconnection detection method by the alarm illustrated in FIG. 1 and the like in an unsealing detection member according to a third embodiment. In the unsealing detection tape 1 illustrated in FIG. 9, the loop wiring 20 is a power supply wiring that supplies power from the battery 13 to the alarm 14. That is, the loop wiring 20 connects the power supply voltage terminal (Vcc) and the ground voltage terminal (GND) of the alarm 14 after the battery 13 is inserted at any position. In this example, the battery 13 is inserted at a position near the ground voltage terminal (GND), but may be inserted at a position near the power supply voltage terminal (Vcc).

The alarm 14 performs periodic communication with an external receiver while power is supplied from the battery 13 via the loop wiring 20. On the other hand, when disconnection occurs in the loop wiring 20, that is, when the unsealing detection tape 1 is peeled off or cut, the alarm 14 stops the periodic communication by cutting off the supply of power. The external receiver can detect that the unsealing detection tape 1 is peeled off or cut based on the stop of the periodic communication.

The alarm 14 is, for example, a wireless communication IC, a wide-area wireless communication IC, or the like. At this time, the alarm 14 may be based on a wireless communication standard in which a keep-alive is specified. Furthermore, in a case where the alarm 14 is a wide-area wireless communication IC, for example, the alarm may transmit GPS information, that is, position information at the time of periodic communication by including a GPS sensor.

[Disconnection Detection Method of Loop Wiring (Method without Periodic Communication)]

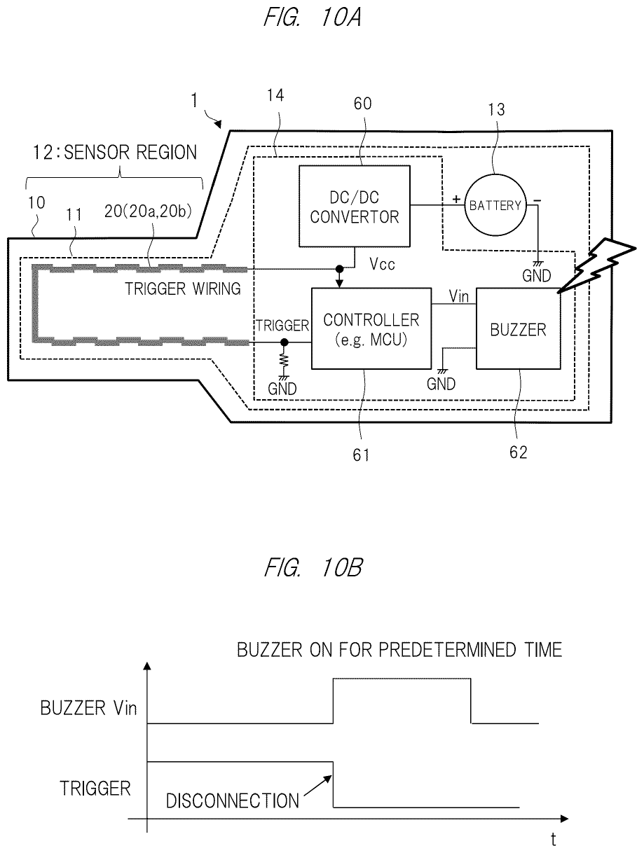

FIG. 10A is a circuit block diagram illustrating a detailed configuration example of the alarm illustrated in FIG. 1 and the like and an example of a disconnection detection method different from that in FIG. 9 in the unsealing detection member according to the third embodiment, and FIG. 10B is a timing chart illustrating an operation example of the alarm in FIG. 10A. The shape of the tape release material 10 and the like illustrated in FIG. 10A is for convenience of description and does not represent an actual shape.

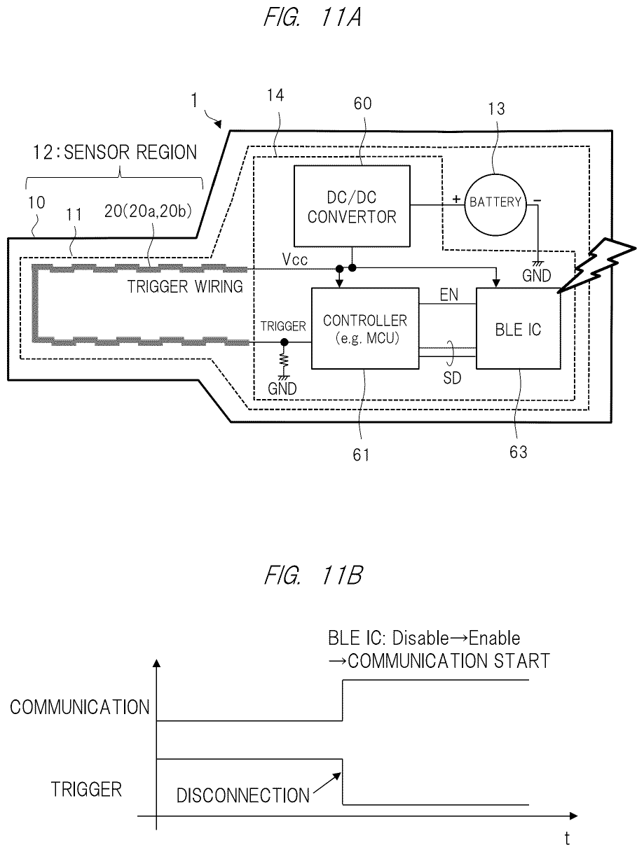

Specifically, in FIG. 10A, in order to describe the configuration around the alarm 14 in detail, the configuration around the alarm 14 is illustrated relatively large, and the periphery of the sensor region 12 is illustrated relatively small. However, this is for description. In practice, a large sensor region 12 may be secured, and a wide region where peeling or cutting can be detected may be secured. The same applies to FIGS. 11A, 12A, 14A, 15A, 16A, 17A, and the like after FIG. 10A.

In the unsealing detection tape 1 illustrated in FIG. 10A, the alarm 14 includes a DC/DC converter 60, a controller 61, and a buzzer 62 which is one of external output apparatuses. The loop wiring 20 is a trigger wiring for transmitting a power supply or a signal generated using power from the battery 13. In this example, the loop wiring 20 transmits the power supply voltage Vcc from the DC/DC converter 60 as the ‘H’ level signal.

The DC/DC converter 60 is, for example, a boost converter or the like, and is inserted into a power supply path from the battery 13 to the controller 61. The boost converter can stabilize the power supply voltage Vcc supplied to the controller 61, and in addition, when the voltage of the battery 13 decreases, the boosted voltage can be supplied to the controller 61. As a result, even when the voltage of the battery is lower than the lower limit voltage based on the specification of the controller 61, the controller 61 can be operated by boosting. Therefore, the life of the unsealing detection tape 1 can be extended. However, the DC/DC converter 60 is not an essential component, and a configuration in which power is directly supplied from the battery 13 to the controller 61 may be used as appropriate.

The controller 61 is, for example, a microcontroller including a processor and a memory, and operates with power supplied from the battery 13 via the DC/DC converter 60. The controller 61 detects the presence/absence of transmission of a power supply or a signal in the loop wiring 20, that is, the trigger wiring. In this example, the controller 61 detects the presence/absence of transmission of the ‘H’ level signal via the trigger wiring.

Specifically, the trigger wiring is connected to the ground voltage GND via, for example, a pull-down resistor which is a high-resistance element provided outside the controller 61 or incorporated in the input terminal of the controller 61. Therefore, as illustrated in FIG. 10B, when the disconnection occurs in the trigger wiring, the signal level of the trigger wiring transitions from the ‘H’ level to the ‘L’ level. When detecting the transition of the trigger wiring to the ‘L’ level, that is, the absence of transmission of the ‘H’ level signal in the trigger wire, the controller 61 outputs a buzzer drive signal Vin at the ON level for a predetermined time.

The buzzer (external output apparatus) 62 receives the on-level buzzer drive signal Vin from the controller 61, and outputs predetermined notification information, for example, a warning sound or the like to the outside of the unsealing detection tape 1 during the on-level period. When the buzzer 62 is a normal buzzer, for example, the controller 61 can cause the buzzer to output a warning sound having a predetermined time-series pattern by outputting the buzzer drive signal Vin having a predetermined time-series pattern. The user can identify the tape ID and the like by the time-series pattern.

Here, the loop wiring 20, that is, the trigger wiring transmits the power supply voltage Vcc from the DC/DC converter 60 as the ‘H’ level signal, but is not limited thereto, and may transmit a power supply or a signal generated using power from the battery 13. For example, one end and the other end of the loop wiring may be connected to an output terminal and an input terminal of the controller 61, respectively, and the controller 61 may output the ‘H’ level signal from the output terminal and detect whether the ‘H’ level signal is input to the input terminal.

FIG. 11A is a circuit block illustrating a detailed configuration example of an alarm different from that in FIG. 10A, and FIG. 11B is a timing chart illustrating an operation example of the alarm in FIG. 11A. In FIG. 11A, unlike the case of FIG. 10A, a BLE IC 63, which is one of wireless communication ICs, is mounted as an external output apparatus in the alarm 14 instead of the buzzer 62. Accordingly, the power supply voltage Vcc from the DC/DC converter 60 is also supplied to the BLE IC 63. In addition, the controller 61 outputs an enable signal EN and serial data SD to the BLE IC 63.

The serial bus that transmits the serial data SD is, for example, a bus for a universal asynchronous receiver/transmitter (UART), an inter integrated circuit (I2C) bus, a serial peripheral interface (SPI) bus, or the like. In addition, here, for convenience of description, the controller 61 outputs an enable signal EN for determining validity/invalidity of communication. However, unlike SPI and the like including a chip select signal (CS), the enable signal EN is unnecessary in a method of detecting a communication start position according to a pattern of the serial data SD, such as the UART and the I2C.

As in the case of FIGS. 10A and 10B, the controller 61 detects the transition of the trigger wiring from the ‘H’ level to the ‘L’ level in response to the disconnection of the loop wiring 20, that is, the trigger wire, as illustrated in FIG. 11B. In response to this, the controller 61 asserts the enable signal EN and sequentially outputs the serial data SD indicating notification information including, for example, the tape ID and the like. The BLE IC 63 detects the start of communication in response to the assertion of the enable signal EN, modulates a carrier signal of, for example, 2.4 GHz with the serial data SD, and transmits the modulated signal to the outside.

Note that, in this example, the BLE IC 63 is used as the external output apparatus. However, for example, even in a case where an ultrasonic buzzer is used, a similar configuration may be used. The ultrasonic buzzer may use an ultrasonic signal as a carrier signal, modulate the ultrasonic signal with the serial data SD, and transmit the ultrasonic signal to the outside.

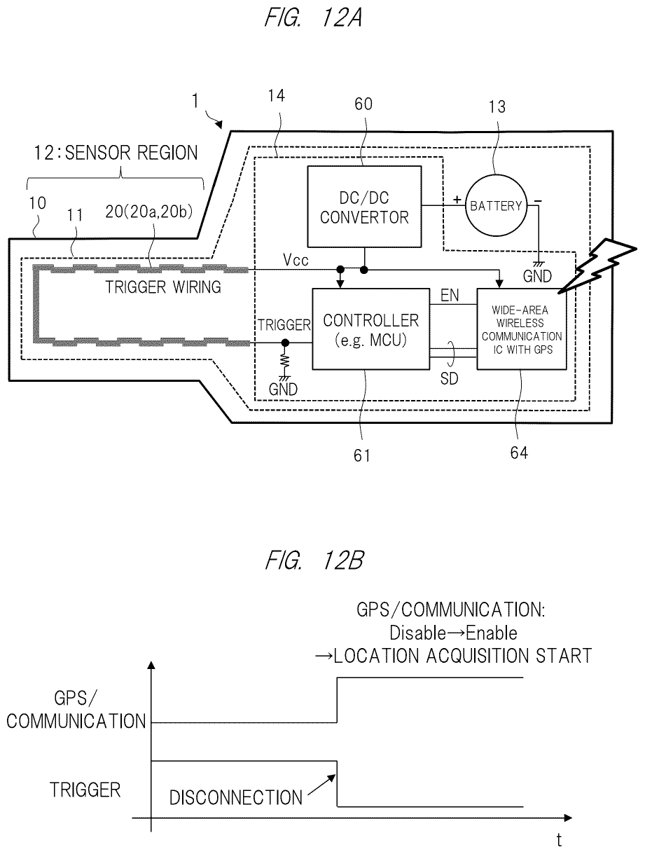

FIG. 12A is a circuit block illustrating a detailed configuration example of an alarm different from that in FIG. 11A, and FIG. 12B is a timing chart illustrating an operation example of the alarm in FIG. 12A. In FIG. 12A, unlike the case of FIG. 11A, a wide-area wireless communication IC 64 with a GPS sensor is mounted instead of the BLE IC 63 as an external output apparatus in the alarm 14. The power supply voltage Vcc from the DC/DC converter 60 is also supplied to the wide-area wireless communication IC 64.

As illustrated in FIG. 12B, the operation of the alarm 14 is similar to that in the case of FIG. 11B. However, unlike the case of FIG. 11B, the wide-area wireless communication IC 64 also acquires position information using a GPS sensor in response to assertion of the enable signal EN. Then, the wide-area wireless communication IC 64 adds the acquired position information to the notification information based on the serial data SD from the controller 61, and transmits the notification information to the outside.

Unlike the configuration example illustrated in FIG. 9, the configuration example illustrated in FIGS. 10A, 11A, and 12A does not require periodic communication, and thus is beneficial from the viewpoint of power consumption of the battery 13 and the life of the unsealing detection tape 1. However, when the periodic communication is performed, it can be periodically confirmed that the unsealing detection tape 1 is normally operating, and thus it is also advantageous to perform the periodic communication from this viewpoint. In addition, in the configuration example of FIG. 10A, there is a case where the content of the notification information is restricted to some extent, but in particular, the configuration example can be operated alone without combining a receiver or the like. On the other hand, the configuration examples of FIGS. 11A and 12A can be difficult to operate as a single unit, but as described in the second embodiment, they are advantageous particularly in a case where the plurality of unsealing detection tapes 1 is centrally managed.

### Main Effects of Third Embodiment

As described above, by using the unsealing detection member according to the third embodiment, effects similar to the various effects described in the first embodiment and the second embodiment can be obtained. In addition, the controller 61, the external output apparatus, and the like constituting the alarm 14 do not need to have particularly high-performance functions, and can be realized by an inexpensive IC. Furthermore, the alarm 14 can be reused as described in the first embodiment. As a result, it is also possible to suppress an increase in product cost and operation cost.

### Fourth Embodiment

### <Details of Unsealing Detection Member>

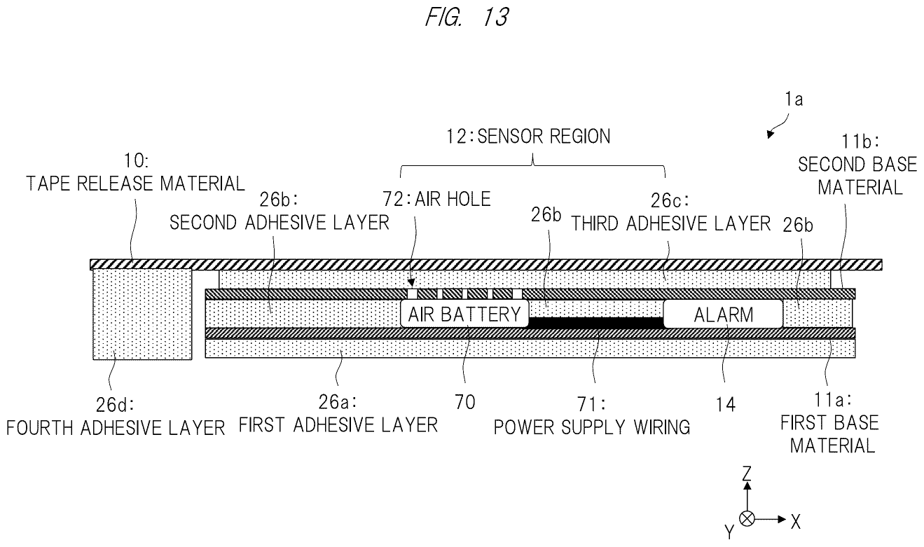

FIG. 13 is a cross-sectional view illustrating a detailed configuration example of an unsealing detection member according to a fourth embodiment. FIG. 13 illustrates an example of a cross-sectional structure of an unsealing detection tape 1a on the XZ plane, as in the case of FIG. 3. As in the case of the first embodiment, the unsealing detection tape 1a illustrated in FIG. 13 also includes a tape base material 11 (11a and 11b) and a tape release material 10 disposed so as to cover the tape base material 11. Further, as in the configuration example illustrated in FIG. 3 and the like, a wiring, here, a power supply wiring 71 is provided in a region between the tape release material 10 and the tape base material 11 (11a and 11b).

Similarly to the configuration example illustrated in FIG. 3, the wiring is configured such that the presence/absence of transmission of a power supply or a signal changes according to whether or not the tape release material 10 is peeled off from the tape base material 11 (11a and 11b). However, in the case of FIG. 3, the state of the wiring changes to the absence/presence of transmission according to the presence/absence of peeling, but in the case of FIG. 13, the state of the wiring changes to the presence/absence of transmission according to the presence/absence of peeling.

Specifically, the unsealing detection tape 1a includes a first base material 11a, a second base material 11b, and a tape release material 10 which are stacked and mounted in this order from the side of the object to be sealed in the Z-axis direction. The first base material 11a and the second base material 11b constitute the tape base material 11 illustrated in FIG. 1. Each member constituting the unsealing detection tape 1a is appropriately adhered using a first adhesive layer 26a, a second adhesive layer 26b, a third adhesive layer 26c, and a fourth adhesive layer 26d.

In the tape base material 11, here, the first base material 11a, an air battery 70 is mounted on one surface in addition to the alarm 14, and the first adhesive layer 26a is formed on the other surface. Further, the power supply wiring 71 for transmitting power from the air battery 70 to alarm 14 is attached to the one surface of first base material 11a. Specifically, the power supply wiring 71 includes a pair of lines that transmits a power supply voltage and a ground voltage. The second base material 11b is disposed such that one surface thereof faces the first base material 11a with the air battery 70 and the alarm 14 interposed therebetween, and the third adhesive layer 26c is formed on the other surface.

The air battery 70 is a battery using oxygen in the air as a positive electrode active material and a metal as a negative electrode active material. Therefore, the air battery 70 generates power when air flows in. By utilizing such characteristics, the air battery 70 generates power by the air flowing in by peeling the tape release material 10 from the tape base material 11. Specifically, the second base material 11b is formed with an air hole 72 for allowing air to flow into the air battery 70 when the tape release material 10 is peeled off from the second base material 11b. The air battery 70 generates power by the air flowing in from the air hole 72. When power is supplied via the power supply wiring 71 by the power generation of the air battery 70, the alarm 14 outputs predetermined notification information to the outside using the power.

The first adhesive layer 26a is a layer for adhering the tape base material 11, here, the first base material 11a and the object to be sealed. The first adhesive layer 26a is formed on the lower surface of the first base material 11a, that is, the entire surface facing the object to be sealed. The second adhesive layer 26b is a layer for adhering the first base material 11a and the second base material 11b, and adhering the first base material 11a and the air battery 70/alarm 14. The third adhesive layer 26c is a layer for adhering the tape release material 10 and the tape base material 11, here, the second base material 11b. The fourth adhesive layer 26d is a layer for adhering the tape release material 10 and the object to be sealed. The outer edge of the unsealing detection tape 1a adheres to the object to be sealed via the fourth adhesive layer 26d.

As in the case of FIG. 3, at least the adhesive strength of the third adhesive layer 26c is lower than that of the first adhesive layer 26a so that the tape release material 10 is first peeled off from the tape base material 11, here, the second base material 11b in the process of peeling the unsealing detection tape 1a from the object to be sealed. In addition, in the process of peeling the unsealing detection tape 1a from the object to be sealed, it is desirable that the adhesive strength of the second adhesive layer 26b be sufficiently high in order to prevent the portion of the air battery 70/power supply wiring 71/alarm 14 from being peeled from the tape base material 11, here, the first base material 11a and broken.

In a case where the adhesive strength of the fourth adhesive layer 26d is higher than the adhesive strength of the first adhesive layer 26a, when the tape release material 10 is peeled off from the object to be sealed, there is a possibility that the entire unsealing detection tape 1a is peeled off from the object to be sealed. In view of the above, the adhesive strength of each adhesive layer is preferably, for example, “second adhesive layer 26b>first adhesive layer 26a>fourth adhesive layer 26d>third adhesive layer 26c”. By setting the adhesive strength of the second adhesive layer 26b to be higher than that of the first adhesive layer 26a, even in a case where the first adhesive layer 26a is peeled off from the object to be sealed after the tape release material 10 is peeled off, the notification operation by the portion of the air battery 70/power supply wiring 71/alarm 14 can be continued.

### <Details of Alarm>

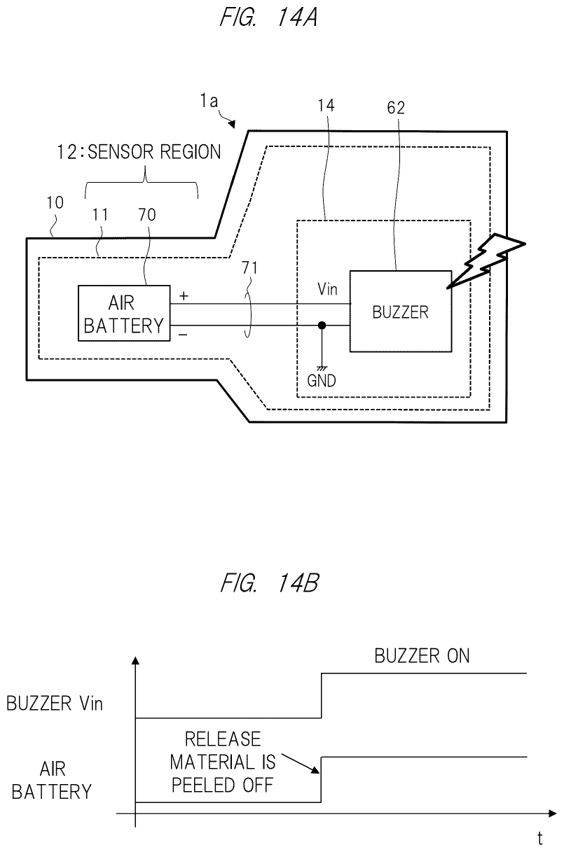

FIG. 14A is a circuit block diagram illustrating a detailed configuration example of the alarm illustrated in FIG. 13, and FIG. 14B is a timing chart illustrating an operation example of the alarm in FIG. 14A. The alarm 14 illustrated in FIG. 14A includes the buzzer 62 that operates by power from the power supply wiring 71. That is, the buzzer drive signal Vin to the buzzer 62 is input by the power supply wiring 71. With such a configuration, as illustrated in FIG. 14B, when the unsealing detection tape la, specifically, the tape release material 10 is peeled off, the air battery 70 generates power, and accordingly, the buzzer 62 outputs a warning sound or the like.

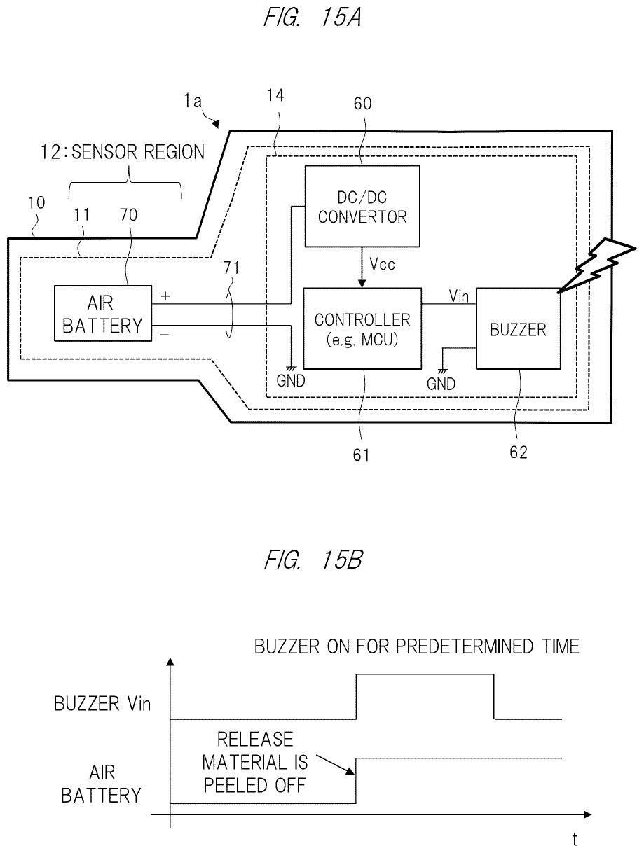

FIG. 15A is a circuit block diagram illustrating a detailed configuration example of an alarm different from that in FIG. 14A, and FIG. 15B is a timing chart illustrating an operation example of the alarm in FIG. 15A. The alarm 14 in FIG. 15A includes the DC/DC converter 60, the controller 61, and the buzzer 62 as in the case of FIG. 10A. However, unlike the case of FIG. 10A, the power supply wiring 71 is not connected to the input terminal of the controller 61, and simply supplies power to the controller 61 via the DC/DC converter 60.

Accordingly, the controller 61 detects the transition to the ‘L’ level in response to the disconnection of the trigger wiring in the case of FIG. 10A, but receives power supply from the air battery 70 via the DC/DC converter 60 in response to the peeling of the tape release material 10 as illustrated in FIG. 15B in the case of FIG. 15A. After receiving the power supply from the air battery 70, the controller 61 outputs the on-level buzzer drive signal Vin for a predetermined time, as in the case of FIG. 10B. The buzzer (external output apparatus) 62 receives the on-level buzzer drive signal Vin from the controller 61, and outputs predetermined notification information, for example, a warning sound or the like to the outside of the unsealing detection tape 1 during the on-level period.

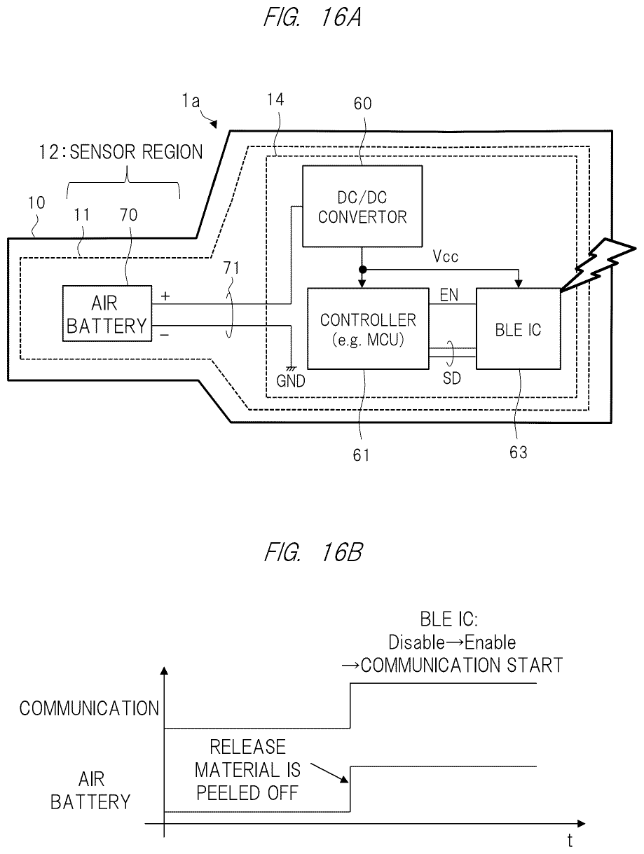

FIG. 16A is a circuit block diagram illustrating a detailed configuration example of an alarm different from that in FIG. 15A, and FIG. 16B is a timing chart illustrating an operation example of the alarm in FIG. 16A. In FIG. 16A, unlike the case of FIG. 15A, a BLE IC 63, which is one of wireless communication ICs, is mounted as an external output apparatus in the alarm 14 instead of the buzzer 62. Accordingly, the power supply voltage Vcc from the DC/DC converter 60 is also supplied to the BLE IC 63.

Similarly to the case of FIG. 15B, the controller 61 and the BLE IC 63 receive power supply from the air battery 70 via the DC/DC converter 60 in response to the peeling of the tape release material 10. After receiving power supply from the air battery 70, the controller 61 and the BLE IC 63 operate similarly to the case of FIG. 11B. That is, the controller 61 outputs predetermined notification information to the BLE IC 63 by the serial data SD, and the BLE IC 63 transmits the serial data SD to the outside of the unsealing detection tape 1a using a wireless signal.

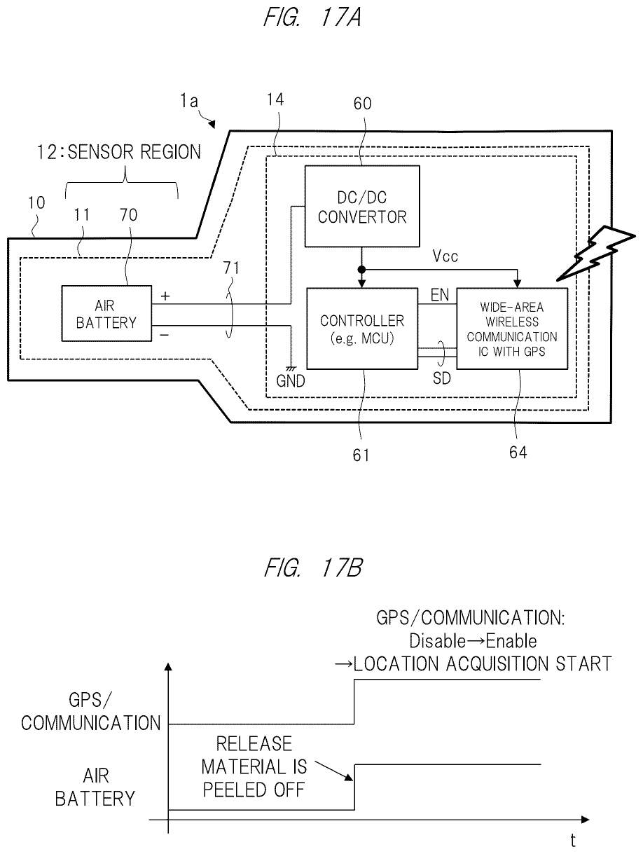

FIG. 17A is a circuit block diagram illustrating a detailed configuration example of an alarm different from that in FIG. 16A, and FIG. 17B is a timing chart illustrating an operation example of the alarm in FIG. 17A. In FIG. 17A, unlike the case of FIG. 16A, a wide-area wireless communication IC 64 with a GPS sensor is mounted instead of the BLE IC 63 as an external output apparatus in the alarm 14. The power supply voltage Vcc from the DC/DC converter 60 is also supplied to the wide-area wireless communication IC 64.

Similarly to the case of FIG. 15B, the controller 61 and the wide-area wireless communication IC 64 receive power supply from the air battery 70 via the DC/DC converter 60 in response to the peeling of the tape release material 10. After receiving the power supply from the air battery 70, the controller 61 and the wide-area wireless communication IC 64 operate similarly to the case of FIG. 12B. That is, the controller 61 outputs predetermined notification information to the wide-area wireless communication IC 64 by the serial data SD, and the wide-area wireless communication IC 64 transmits the serial data SD and positional information obtained by the GPS sensor to the outside of the unsealing detection tape 1a using the wide-area wireless signal.

### Main Effects of Fourth Embodiment

As described above, the unsealing detection member according to the fourth embodiment includes the air battery in which the presence or absence of power generation changes according to whether or not the tape release material 10 is peeled off from the tape base material 11 and the wiring that transmits the power from the air battery, and performs the unsealing detection using the presence/absence of transmission of the power in the wiring. This makes it possible to detect that the tape has been peeled off. In addition, as in the case of the first embodiment and the second embodiment, since the unsealing detection can be performed only by attaching the unsealing detection member to the object to be sealed, improvement in convenience, reduction in operation cost, and the like can be realized.

### Fifth Embodiment

### <Modification of Trigger Wiring/Loop Wiring>

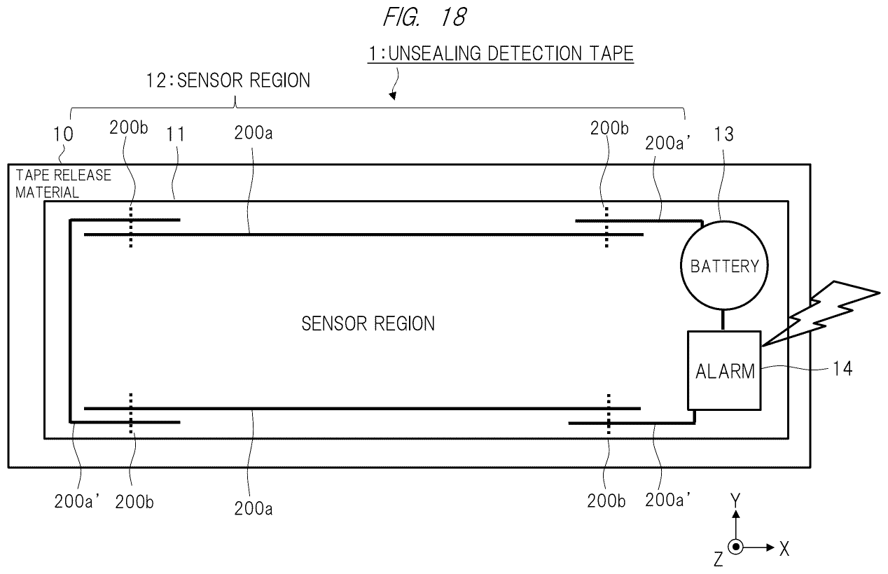

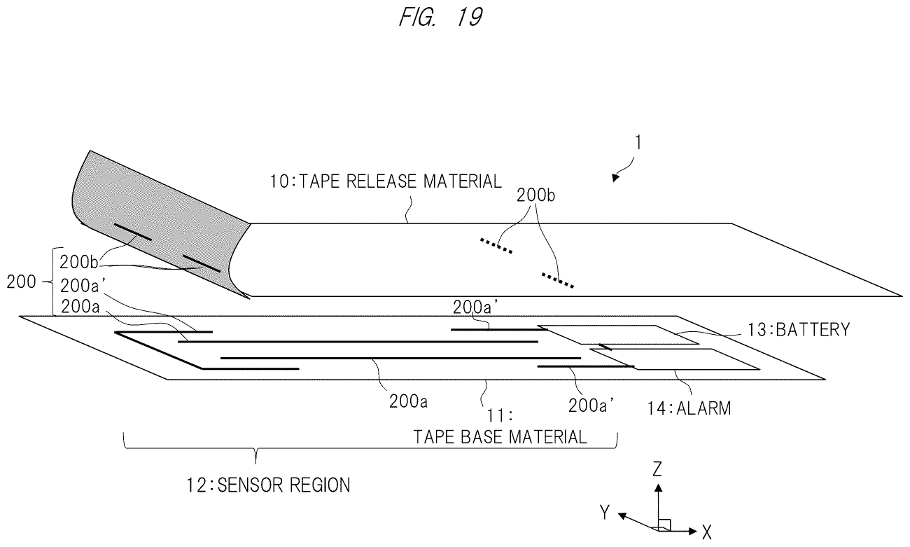

FIG. 18 is a top view illustrating a schematic configuration example of an unsealing detection member according to a fifth embodiment. FIG. 19 is a perspective view illustrating a schematic configuration example of the unsealing detection member according to the fifth embodiment. In the fifth embodiment, the configuration of the trigger wiring or the loop wiring as an example thereof in the unsealing detection member according to the first to third embodiments is modified to another configuration.

For example, in the configuration of the loop wiring 20/trigger wiring according to the first to third embodiments, as illustrated in FIG. 2, a first wiring 20a forming a part of the loop wiring 20 is attached to the tape base material 11, and a second wiring 20b forming another part of the loop wiring 20 is attached to the tape release material 10. When the tape base material 11 is covered with the tape release material 10, two intermittent annular wires are covered with each other so as to be in contact with each other.

On the other hand, in the loop wiring 200/trigger wiring illustrated in FIGS. 18 and 19, a third wiring 200a and a fourth wiring 200a′ forming a part of the loop wiring 200 are attached to the tape base material 11, and a second wiring 200b forming another part of the loop wiring 200 is attached to the tape release material 10. In the third wiring 200a and the fourth wiring 200a′ attached to the tape base material 11, the loop wiring is not completed, and is disconnected at positions corresponding to the four corners of the substantially rectangular sensor region 12. The second wiring 200b is a wiring arranged to connect the third wiring 200a and the fourth wiring 200a′ at positions corresponding to the four corners, in other words, bridge them when the tape base material 11 is covered with the tape release material 10. When the tape base material 11 is covered with the tape release material 10, the third wiring 200a and the fourth wiring 200a′ form the loop wiring 200 via the second wiring 200b.

### Main Effects of Fifth Embodiment

Also in the configuration of the loop wiring 200/trigger wiring illustrated in FIGS. 18 and 19, peeling can be detected and cutting can be detected. As an advantage of the configuration of the loop wiring 200/trigger wiring illustrated in FIGS. 18 and 19, it is not necessary to increase the accuracy of alignment of the tape release material 10 with respect to the tape base material 11 as compared with the loop wiring 20/trigger wiring illustrated in FIG. 2, and production is easy, and cost reduction can be expected. In addition, when a third party peels off the rectangular tape release material 10, the tape release material is peeled from the position including at least the four corners, therefore, the detection accuracy is substantially sufficient. The other effects are the same as those of the first to third embodiments, and since the unsealing can be detected only by attaching the unsealing detection member to the object to be sealed, improvement in convenience, reduction in operation cost, and the like can be realized.

When the method of each embodiment is used, the unsealing of the object to be sealed can be detected using a simple and reusable unsealing detection member. For example, by using the unsealing detection member for sealing the inspection point of the infrastructure facility, it is possible to improve the efficiency of abnormality detection of the infrastructure facility. This makes it possible to contribute to the United Nations' sustainable development goals (SDGs): “Goal 9: Build resilient infrastructure, promote inclusive and sustainable industrialization and foster innovation”.

Although the invention made by the present inventors has been specifically described based on the embodiments, the present invention is not limited to the above embodiments, and various modifications can be made without departing from the gist of the present invention. For example, the above-described embodiments have been described in detail in order to describe the present invention in an easy-to-understand manner, and are not necessarily limited to those having all the described structures. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

For example, when the unsealing detection member is used for detecting cutting, slits may be appropriately formed in the tape release material 10 in FIG. 2, specifically, the tape release material 10 and the film substrate 21b in FIG. 3, and the like, for example, so as to facilitate cutting.

### EXPLANATION OF REFERENCE CHARACTERS

1 Unsealing detection tape
10 Tape release material
11 Tape base material
11a First base material
11b Second base material
12 Sensor region
13 Battery
14 Alarm
20 Loop wiring
20a First wiring
20b Second wiring
25a, 26a First adhesive layer
25b, 26b Second adhesive layer
25c, 26c Third adhesive layer
30 Object to be sealed
35 Information terminal
41 Two-dimensional code
45 Initial installation information
47 Management server
51a to 51e Notification information
55 Relay apparatus
60 DC/DC converter
61 Controller
70 Air battery
71 Power supply wiring
72 Air hole

1. An unsealing detection member configured to be used by being attached to an object to be sealed and detect unsealing of the object to be sealed, the unsealing detection member comprising:
a tape base material attached to the object to be sealed;
a tape release material disposed to cover the tape base material and configured to be peeled off from the tape base material in a process of peeling the unsealing detection member from the object to be sealed;
a battery mounted on the tape base material;
a first wiring attached to the tape base material and configured to form a part of a loop wiring;
a second wiring configured to form another part of the loop wiring and attached to the tape release material to be in contact with the first wiring; and
an alarm mounted on the tape base material and configured to operate with power from the battery and output notification information reflecting information indicating presence/absence of disconnection of the loop wiring to the outside.

2. The unsealing detection member according to claim 1,
wherein the tape release material has an area larger than an area of the tape base material, and is disposed so as to completely cover the tape base material.

3. The unsealing detection member according to claim 1, comprising:
a first adhesive layer configured to adhere the tape base material and the object to be sealed; and
a third adhesive layer configured to adhere the tape release material and the tape base material,
wherein adhesive strength of the third adhesive layer is lower than adhesive strength of the first adhesive layer.

4. The unsealing detection member according to claim 3, comprising:
a second adhesive layer configured to adhere the tape base material to the battery and the alarm,
wherein adhesive strength of the second adhesive layer is higher than the adhesive strength of the first adhesive layer.

5. The unsealing detection member according to claim 1,
wherein the tape release material is a release paper, and
wherein a tape ID for identifying each of the unsealing detection members is printed on the release paper.

6. The unsealing detection member according to claim 1,
wherein the loop wiring is a power supply wiring configured to supply power from the battery to the alarm, and
wherein the alarm performs periodic communication with the outside while the power from the battery is supplied.

7. The unsealing detection member according to claim 1,
wherein the loop wiring is a trigger wiring through which a power supply or a signal is transmitted, and
wherein the alarm includes:
a controller configured to operate with power from the battery and detect presence/absence of transmission of the power supply or the signal in the trigger wiring; and
an external output apparatus configured to output the notification information to the outside when the controller detects absence of the transmission.

8. The unsealing detection member according to claim 7,
wherein the external output apparatus includes an ultrasonic buzzer configured to output the notification information using an ultrasonic signal.

9. The unsealing detection member according to claim 7,
wherein the alarm includes a boost converter configured to be inserted into a power supply path from the battery to the controller and supply a boosted voltage to the controller when the voltage of the battery decreases.

10. The unsealing detection member according to claim 7,
wherein the notification information includes a tape ID for identifying each of the unsealing detection members, the tape ID being acquired from the controller.

11. An unsealing detection member configured to be used by being attached to an object to be sealed and detect unsealing of the object to be sealed, the unsealing detection member comprising:
a tape base material attached to the object to be sealed;
a tape release material disposed to cover the tape base material and configured to be peeled off from the tape base material in a process of peeling the unsealing detection member from the object to be sealed;
an air battery mounted on the tape base material and configured to generate power by air flowing in when the tape release material is peeled off from the tape base material;
a power supply wiring attached to the tape base material and configured to transmit power from the air battery; and
an alarm mounted on the tape base material and configured to output predetermined notification information to the outside using the power when the power is supplied via the power supply wiring.

12. The unsealing detection member according to claim 11,
wherein the tape release material has an area larger than an area of the tape base material, and is disposed so as to completely cover the tape base material.

13. The unsealing detection member according to claim 11, comprising:
a first adhesive layer configured to adhere the tape base material and the object to be sealed; and
a third adhesive layer configured to adhere the tape release material and the tape base material,
wherein adhesive strength of the third adhesive layer is lower than adhesive strength of the first adhesive layer.

14. The unsealing detection member according to claim 13,
wherein the tape base material includes
a first base material on which the air battery and the alarm are mounted on one surface and the first adhesive layer is formed on another surface, and
a second base material disposed such that one surface thereof faces the first base material with the air battery and the alarm interposed therebetween, and the third adhesive layer is formed on another surface,
wherein the unsealing detection member includes a second adhesive layer configured to adhere the first base material and the second base material, and
wherein an air hole for allowing air to flow into the air battery is formed in the second base material when the tape release material is peeled off from the second base material.

15. The unsealing detection member according to claim 11,
wherein the alarm includes an ultrasonic buzzer configured to output the notification information using an ultrasonic signal when power is supplied via the power supply wiring.

16. An unsealing detection system comprising:
an unsealing detection member configured to be used by being attached to an object to be sealed and detect unsealing of the object to be sealed; and
a relay apparatus configured to relay information transmission from the unsealing detection member to a management server,
wherein the unsealing detection member includes:
a tape base material attached to the object to be sealed;
a tape release material disposed so as to cover the tape base material and configured to be peeled off from the tape base material in a process of peeling the unsealing detection member from the object to be sealed;
a battery mounted on the tape base material;
a wiring disposed in a region where the tape base material and the tape release material face each other, and configured such that presence/absence of transmission of a power supply or a signal changes according to whether or not the tape release material has been peeled off from the tape base material; and
an alarm mounted on the tape base material and configured to operate with power from the battery and output first notification information reflecting the information on the presence/absence of transmission in the wiring to the outside; and
wherein the relay apparatus receives the first notification information from the alarm, and transmits second notification information generated by reflecting the first notification information to the management server.

17. The unsealing detection system according to claim 16,
wherein the alarm is an ultrasonic buzzer configured to output the first notification information using an ultrasonic signal, and
wherein the relay apparatus includes an ultrasonic microphone configured to extract the first notification information from the ultrasonic signal.

18. The unsealing detection system according to claim 16,
wherein the alarm is a wireless communication IC configured to transmit the first notification information using a first wireless signal, and
wherein the relay apparatus extracts the first notification information from the first wireless signal, generates the second notification information by reflecting the first notification information, and transmits the second notification information to the management server by using a second wireless signal.

19. The unsealing detection system according to claim 16,
wherein the first notification information includes a tape ID for identifying each of the unsealing detection members, and
wherein the second notification information includes a relay apparatus ID for identifying the relay apparatus in addition to the tape ID.

20. The unsealing detection system according to claim 16,
wherein the tape release material is a release paper,
wherein a tape ID for identifying each of the unsealing detection members is printed on the release paper,
wherein the management server stores initial installation information indicating a correspondence relationship between the tape ID and sealing date and time information obtained when the unsealing detection member is attached to the object to be sealed or position information, and
wherein the initial installation information is obtained by a user reading the tape ID printed on the release paper using an information terminal and associating the sealing date and time information or the position information with the tape ID using the information terminal.
